(19) United States
(12) Patent Application Publication
(10) Pub. No.: US 2010/0261497 A1
(43) Pub. Date: Oct. 14, 2010

(54) REDUCING DELAYS IN PUSH TO TALK OVER CELLULAR SYSTEMS

(75) Inventors: David Cooper, Thatcham,Berkshire (GB); David Stacey, Bracknell, Berhshire (GB)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/303,846

(22) PCT Filed: Jun. 8, 2007
(86) PCT No.: PCT/GB07/02142

§ 371 Date: Jun. 17, 2010

(30) Foreign Application Priority Data
Jun. 9, 2006 (GB) 0611454.0

(51) Int. Cl. H04B 7/00

(52) U.S. Cl. 455/519

(57) ABSTRACT

In a push-to-talk communication system, frames are sent by a talking device before confirmation that the device has the floor. These are flagged, sent for a limited duration and buffered in a listening device. Playback is triggered either by receipt of frames flagged as ‘confirmed’ or by receipt of the ‘receiving talk burst’ message from a server.

### OVERVIEW OF THE SYSTEM

The OMA Open Market Alliance Push to talk over Cellular (PoC) system is intended to provide a walkie-talkie like function for users with cellular phones. PoC allows user voice and data communications between groups of recipients such as in FIG. 1 “Example of a PoC 1-to-many Group session (voice transmission)” below.

In push to talk over cellular, the mobile handset is referred to as a PoC Client which communicates with ‘PoC Servers’ in the network. One of these servers performs a role called the ‘PoC controlling function’; all PoC clients must request permission to speak (make a request for the ‘floor’ to be granted) from the PoC controlling function. Typically the user does this by pressing a button on the handset. When he gets permission to speak this is normally indicated by an audible ‘talk’ tone. When a user speaks, he transmits a “Talk Burst” or more generally a “Media Stream” which may contain audio, video or other information.

The system as currently implemented tends to suffer from a number of undesirable delays which degrade the user experience. This proposal is concerned with the minimization of all these delay factors in the context of the OMA PoC architecture.

### Overview OF OMA PoC Architecture

Each user's handset is called a “PoC Client”. The PoC session itself is controlled by a “Controlling PoC function” which performs management functions such as admission and determining which user is allowed the floor. PoC clients communicate with the PoC Controller via a “Participating PoC Function”. If the PoC client belongs to the same network as the Controlling PoC function, then the Controlling and Participating PoC function may be one and the same entity. Otherwise they are different entities, and the participating PoC function resides in the same network as the PoC Client. This is illustrated in FIG. 2 “Relationship between Controlling PoC Function, Participating PoC Functions and the PoC Clients”.

Media and media-related signalling such as Talk Burst Control messages originate from the PoC Client that currently has the floor, is always routed through the controlling PoC function, and terminates at the other PoC Clients. For efficiency it may bypass the Participating PoC Functions.

Session control signalling (such as joining a session, leaving a session, setting up a session) is always routed via the Participating PoC function.

### System Delay Analysis

The speaker, having pressed the PTT button, experiences some apparent delay before the talk tone is generated (assuming that the request to speak is successful); this time is illustrated as T_{floor} in the following figures. In general, the less delay that the speaker perceives the better.

Second, there is a perceptible delay from when the speaker pushes the PTT button until the listener first hears the speaker talking. It is important to minimize this delay to prevent ‘clashes’ which occur when the conversation appears to be paused but in fact one speaker has already asked for the floor. This delay is called T_{ptt-play} in the following.

Also, once the speaker is talking, there is a delay from the voice of the speaker to the ear of the user (‘end to end’ delay). This delay comprises a number of factors, including but not limited to:
Time to code the voice of the speaker into discrete digital voice frames or packets.
Time to transmit a packet from speaker's handset to listener's handset.
Decoding delay at listener's handset.

It is desirable to minimize end to end ‘mouth to ear’ delay.

In the OMA PoC system, the delay factors at present include the following:
1. A user wishing to talk pushes a button, and a talk_burst_request message is sent from PoC Client to PoC controller requesting the floor.
2. A Message talk_burst_confirm comes from Controlling PoC function to PoC client granting the floor (assuming that request is successful). Also, a corresponding receiveing_talk_burst message is sent to all other PoC clients in the session to indicate that another user has gained the floor.
3. The PoC client indicates to the speaker that he has the floor (typically by playing an audible tone). Now he can start talking.
4. Speech is encoded into frames and transmitted from PoC Client to the other PoC listeners. Delay is variable, but suppose minimum delay is Tₑ₂ₑ.
5. Speech frames are buffered at the PoC listeners. To cope with the fact that the delay is variable from the minimum value, the PoC listening client must first collect a buffer of duration Tⱼᵢₜ where this should typically be long enough to ensure that 99% of frames are received in time to play them out.

This is shown below in FIG. 3 where the time delays are as follows:
T_{floor}: this is the delay from push button to an indication that the user is allowed to speak. Typically this is less than one second (Ref 2).
T_{send}: this is the delay from push button to when the sending client is allowed to start transmitting speech frames towards the network. For legacy systems T_{send}=T_{floor}.
Tₑ₂ₑ: this is the transmission delay across an IP network. Typically this is in the region of 50-250 ms (Ref 2, Ref 3).
Tⱼᵢₜ: this is the transmission delay jitter or variation across an IP network. Depending on the network it can range up to 300 ms (Ref 5).

Then the time from the speaker pressing the PTT button and the listener first being able to hear the speaker is:

Then T_{ptt-play}=T_{floor}+Tₑ₂ₑ+Tⱼᵢₜ

### Delay Jitter Value

The delay jitter Tⱼᵢₜ is significant, and in this proposal a method will be shown that reduces the overall delay in playing out the voice or media from the value above by at least Tⱼᵢₜ.

Ref 3 reports delay jitter values in the region of 50 ms but which tends to increase with increasing end to end delay. In ref 4, the 90 percentile jitter over for video frames over the public internet is recorded as being as being as long as 1 sec (this work does not deal with speech frames). Ref 5 performs very comprehensive measurement on voice frame delay and delay jitter on Internet Backbones between cities in the USA. It reports in many cases low minimum delays (50 ms) but with delay variation up to 300 ms for a significant percentile of cases. It found the internet backbone links have delay jitter properties that tend to be a property of that link and can be classified as: high, alternating two state, periodic spikes, or consistently low. Ref 6 reports average figures 2 sec for Tₜₐₗₖ, and 1.3 sec for inter voice delay.

FIGS. 4 and 5 are taken from this study, showing an example of periodic spikes.

### SUMMARY OF THE INVENTION

The present invention provides a push-to-talk cellular communication system as described in claim 1. Note that the right to ‘talk’ could mean in practice the right to speak or the right to send a media stream. The initial segment of speech or media will have a limited duration. Among other factors it will be limited by the size of the buffer in the client devices, but preferably it is limited in a more positive way, for example on the basis of measured values of the performance of the network, such as the delay jitter. This can be relayed to the client devices by a server.

In another aspect as described in claim 9 the system is characterised in that the duration of the initially transmitted segment is dependent on the delay jitter or other aspects of delay in the system.

The invention also provides a client device suitable for the system of the invention as described in claim 11.

### BRIEF DESCRIPTION OF THE DRAWINGS

Embodiments of the invention will now be described by way of example only and with reference to the accompanying drawings in which:

FIG. 1. schematically illustrates a one-to-many push to talk group session;

FIG. 2. illustrates the relationship between functions and clients as described above;

FIG. 3. is a Turing diagram illustrating the delays present in a legacy push-to-talk system;

FIGS. 4 and 5 are graphs based on studies of delay in push-to-talk systems;

FIG. 6 is a timing diagram similar to FIG. 3 showing the improvement expected with the present invention;

FIG. 7 is another timing diagram similar to FIGS. 3 and 6 showing an optical enhancement to the system of FIG. 6.

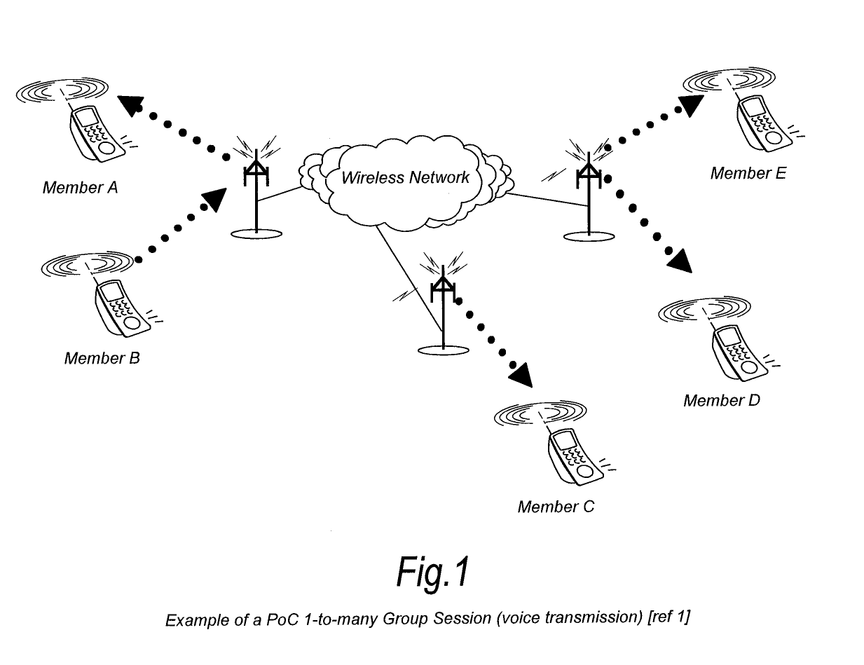

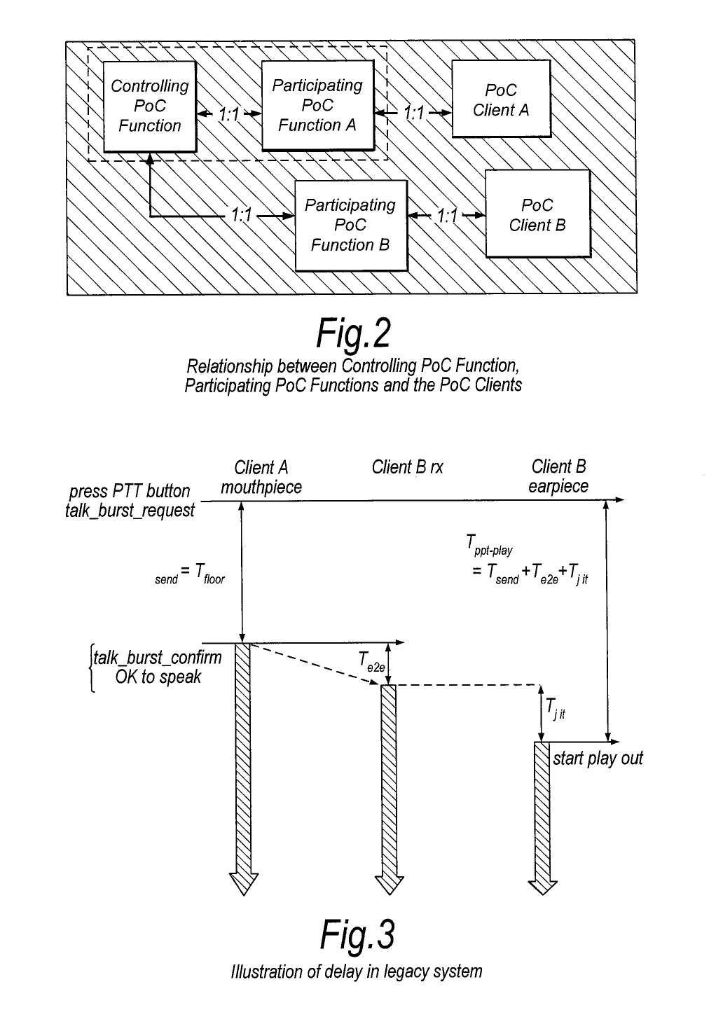

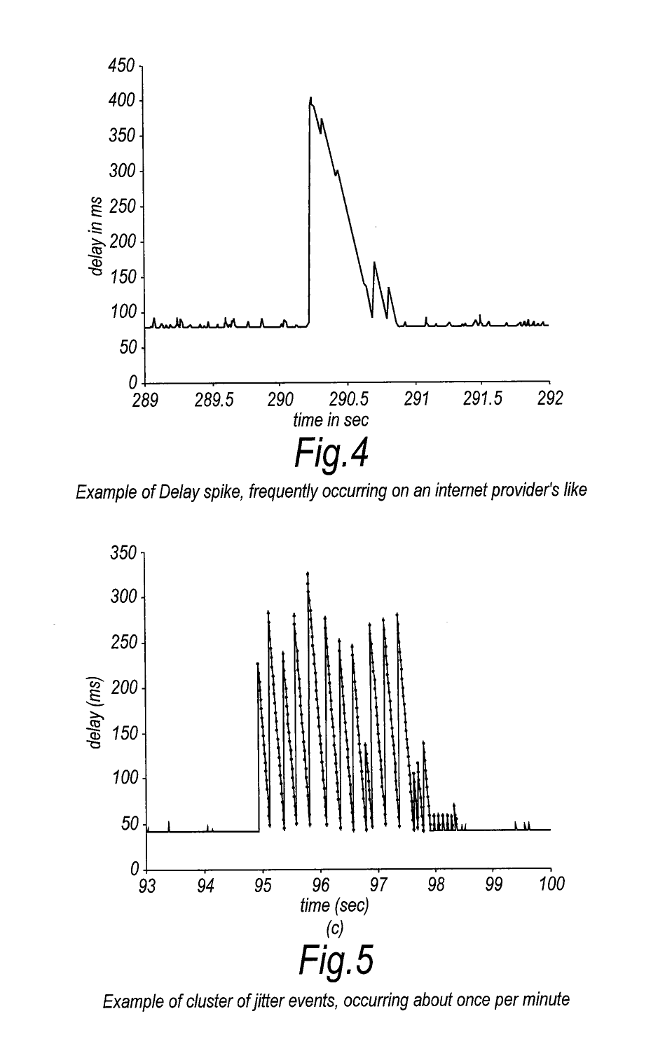

### DETAILED DESCRIPTION

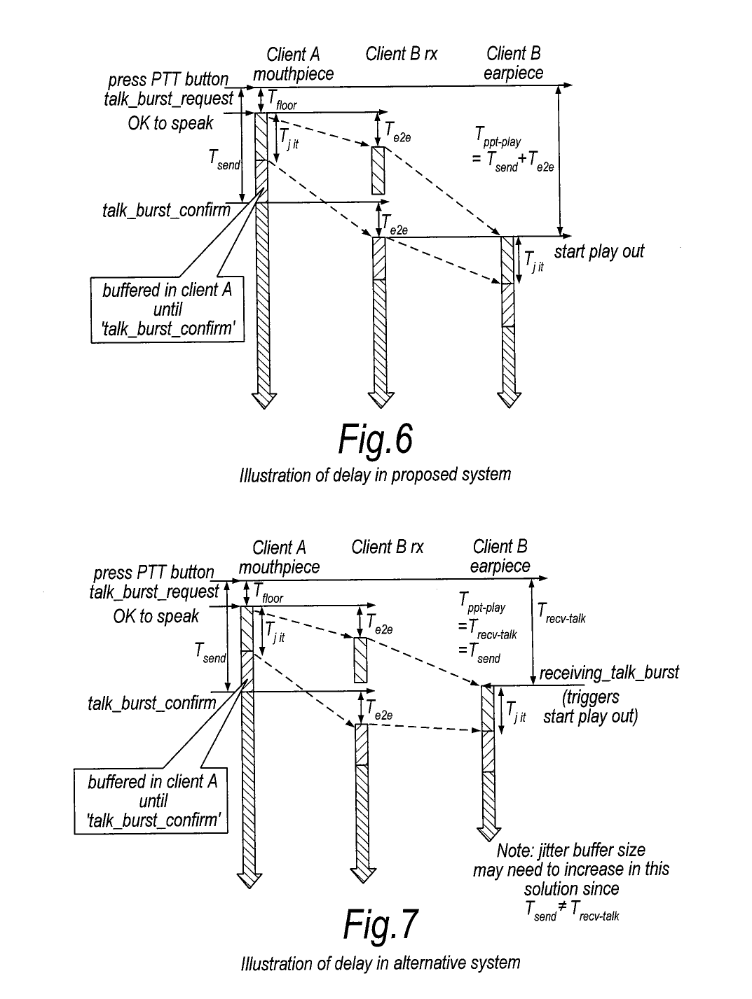

The invention relies on the introduction of a predictive grant mechanism, in which according to circumstances (for example there has been silence for a certain period), the ‘floor granted’ indication is indicated to the user prior to confirmation being received from the Controlling PoC Function. Thus T_{floor}<T_{send}. FIG. 6 below indicates timing.

Then the user will be able to start talking before the PoC Client receives the talk_burst_confirm message that confirms he has the floor (therefore there is a slight risk that the user will be apparently granted the floor only to have it taken away). As shown in the figure below, the talking PoC client starts to send a media stream before confirmation is received. But it only sends the first segment of the media stream, with a duration of Tⱼᵢₜ. After this it stores the media stream until it receives a confirmed floor granted indication.

Note that the PoC client is not expected to be aware of the prevailing value of the delay jitter. This can be notified to the client by the server. The time delay T_{floor} before the client indicates to the user that he has the floor can also in principle be notified.

This first segment of the media stream is buffered in the PoC server until it trnamission to the listening PoC client, where it may be buffered and used to initialize the media jitter buffer. Each frame of the media stream contains a binary flag called the “predictive/confirmed floor grant flag” which indicates that this frame was transmitted before confirmation of floor grant has been received by the talking PoC client (predictive floor grant) or after confirmation is received (confirmed floor grant) The frames comprising the first segment of the media stream are marked with a flag indicating that they are sent with “predictive floor grant”, with the result that the PoC client does not play them out. This flag is a novel aspect of this proposal.

The speaking PoC client then buffers the media stream until it receives a confirmation of floor granted. At this time it starts to send the media stream towards the controlling PoC function which relays it towards the listening PoC clients.

Each frame in the media frame is now marked a flag indicating they are sent with “confirmed floor grant”, with the result that the listening PoC client can start to play out the media stream as soon as it gets the first such frame, in the knowledge that the media stream data will from now on arrive continuously until it finally stops.

The advantage of this method is that the delay from the talker requesting the floor to the listeners hearing the start of the media stream is reduced. In addition, the floor grant delay perceived by the talker is reduced.

The extent of this reduction is as follows. As noted above, in the legacy system this delay is:

T_{ptt-play}=T_{floor}+Tₑ₂ₑ+Tⱼᵢₜ

In the new system the delay is:

T_{ptt-play}=T_{floor}+Tₑ₂ₑ

As can be seen, the delay to fill the jitter buffer is eliminated.

For example, if floor grant delay is 500 ms, minimum end to end delay is 100 ms, maximum jitter is 400 ms, this equates to 40% improvement.

### Enhancement

An enhancement to the above solution is now described that utilises the Talk Burst Control messages to minimise the delay further. Talk Burst Control messages are used by the Controlling PoC server to control the granting of the floor. In normal operation, the Controlling PoC Server sends a “Talk Burst Confirm” message to the Client to inform the Client that it has been granted the floor; in parallel the Server sends a “Receiving_Talk_Burst_from_User X” message to all other to inform them that Client X has been granted the right to speak.

In this alternate solution the behaviour of the talking client (client A) is exactly as described above. However the behaviour of the receiving client is modified such that immediately upon receiving the “Receiving Talk Burst from User A” message it checks the size of its received buffer from User A. If it has received the initial Tⱼᵢₜ amount of data it is able to immediately proceed playing out this data rather than waiting for the subsequent data packets to arrive. Under normal conditions if we assume that the “Receiving Talk Burst from User X” is received at approximately the same time as the “Talk Burst Confirm” arrives at Client A then the extent of this reduction is as follows.

T_{ptt-play}≈T_{send}

This is illustrated in FIG. 7.

### Second Enhancement

In the PoC system the total delay is made up of two key components:
Right to Speak delay: Delay between the user pressing the talk button and being granted the floor.
Mouth to Ear delay: Delay between the speech being recorded at the talking client until it is played out at the receiver.

The enhanced predictive grant mechanisms described above reduce both the total end-to-end delay and the right to speak delay but increase the mouth to ear delay over conventional PoC systems (due to the introduction of the client transmit buffer).

In certain situations it may be preferable that whilst maintaining the overall end-to-end delay an increased right to speak delay is introduced in return for a lower mouth to ear delay. Effectively the received speech is less ‘stale’ when played out at the receiver.

In this second alternative, this can be achieved by the talking client determining the time to indicate ‘Ok to speak’ to the user, based on the requested length of the limited initial segment and historical measurements of delay from floor request to floor grant.

In one embodiment, to simultaneously minimize T_{ptt-play} and to ensure that the speech is as ‘fresh’ as possible when it arrives at the listener, the Ok to Speak indication should ideally be sent at T_{floor}−Tₑ₂ₑ−Tⱼᵢₜ and at this point Tⱼᵢₜ amount of data should be collected and sent as before. In this scenario the end to end delay remains at T_{floor} approximately. The advantage of this method is that the information received by client B is less stale than that used previously.

In one embodiment the receiving client can start to play out the speech immediately upon receipt without further delay, subject to a sufficient amount being received to allow for delay jitter.

### REFERENCES

Ref 1: Push to talk over Cellular (PoC)—Architecture Candidate Version 1.0—27 Jan. 2006, Open Mobile Alliance

Ref 2: http://www.incodewireless.com/media/whitepapers/2004/PoC_White_Paper-Feb_{—}2004.pdf. (www.nordstream.se)

Ref 3: Measuring intemet telephony quality: where are we today: O Hagsand, J Hanson, I Marsh, Globecomm'99.

[END OF DOCUMENT]

Ref 4: An Empirical Study of RealVideo Performance Across the Internet, Yubing Wang, Mark Claypool, Zheng Zuo, ACM SIGCOMM Internet Measurement Workshop 2001

Ref 5: Assessing the Quality of Voice Communications Over Internet Backbones, Markopoulou, Tobagi, Karam, 2003, IEEE ACM Trans Networking.

Ref 6: Design of Push to Talk Client for Performance Measurement, Tuuka Karvonen, Thesis, 3.2.05 Celtius Oy

1. A method for use with a push to talk cellular communication system operable on a mobile communication network to connect mobile communication devices as clients of the system, in which:
a client requests the right to ‘talk’
the right to ‘talk’ is granted by a central controlling function
a confirmation is sent from the controlling function to the client
the method comprising:
anticipating the confirmation from the controlling function, and transmitting, by the requesting client, an initial segment of speech or media information in advance of the confirmation,
storing the initial segment of speech or media in a listening client,
starting transmission, by the requesting client, of the remainder of the speech or media, on receipt of a confirmation message from the controlling function, and
starting to play out, by the listening client, the speech or media according to a trigger condition,
wherein:
an initial segment of speech or media of limited duration is sent by the PoC client,
data frames contained in speech or media may be marked with a “predictive/confirmed floor grant flag” by the transmitting client such that data frames transmitted before the transmitting client receives a message to confirm floor grant are marked as “predictive” and data frames transmitted after this are marked as “confirmed”.

2. A method as claimed in claim 1, in which the trigger for the listening client is the receipt of a portion of speech or media marked as “confirmed”.

3. A method as claimed in claim 1, in which the listening client is triggered when it receives a message notifying it that another client is granted the right to send data frames and it has received some frames marked as predictive.

4. A method as claimed in claim 1, in which the duration of the initial segment of speech or media is limited on the basis of information provided by a push to talk server.

5. A method as claimed in claim 4 in which the listening client is not triggered until it has received the whole of said initial segment of speech or data.

6. A method as claimed in claim 5 in which the duration is based on the prevailing delay jitter present in the network.

7. A method as claimed in claim 6 in which the server notifies the requesting client of the delay jitter and the client uses this to determine the duration of the initial segment of speech or media.

8. A method as claimed in claim 1 in which a signal is transmitted to the user of the requesting client to permit the user to send data and the sending of the signal is delayed on the basis of the delay between the user pressing the talk button and being granted the floor and delay between the speech being recorded at the talking client until it is played out at the receiver.

9. A method for use with a push to talk cellular communication system operable on a mobile communication network to connect mobile communication devices as clients of the system, in which:
a client requests the right to “talk”
the right to “talk” is granted by a central controlling function
a confirmation is sent from the controlling function to the client
the method comprising:
anticipating the confirmation from the controlling function, and transmitting, by the requesting client, an initial segment of speech or media information in advance of the confirmation,
storing the initial segment of speech or media in a listening client,
starting transmission, by the requesting client, the remainder of the speech or media, on receipt of a confirmation message from the controlling function, and
starting to play out, by the listening client, the speech or media according to a trigger condition,
wherein:
the duration of the initial segment of speech or data is limited on the basis of the prevailing delay jitter or other delay factors in the system.

10. A method as claimed in claim 9 in which a server notifies the client of the prevailing delay jitter and the client uses this to limit the duration of the initial segment speech or media information.

11. A method for use with mobile communication device for use as a client in a push to talk cellular communication system comprising:
generating a signal requesting the right to “talk,”
receiving and responding to a message from a controlling function confirming that the right to “talk” has been granted,
transmitting an initial segment of speech or media information in advance of receiving the confirming message,
marking data frames contained in speech or media with a “predictive/confirmed floor grant flag” such that data frames transmitted before receipt of a message to confirm floor grant are marked as “predictive” and data frames transmitted after this are marked as “confirmed”.

12. A method as claimed in claim 11 having functionality to operate in listening mode in which received frames marked as predictive are buffered before being played to the user.

13. A method as claimed in claim 12 in which the playing of received frames is triggered by the receipt of a portion of speech or media marked as “confirmed”.

14. A method as in claim 12 in which the playing of received frames is triggered by the receipt of a message notifying it that another client is granted the right to send data frames and it has received some frames marked as predictive

15. A method as claimed in claim 11 further comprising limiting the duration of the initial segment on the basis of information supplied by a server.
